(19) United States
(12) Patent Application Publication
(10) Pub. No.: US 2007/0276760 A1
(43) Pub. Date: Nov. 29, 2007

(54) Digital Copyright Management Using Secure Device

(75) Inventors: Toshiki Kanehara, Tokyo (JP); Mitsuhiro Sato, Kanagawa (JP); Takashi Shimojima, Chiba (JP); Tomonori Uemura, Tokyo (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/568,400

(22) PCT Filed: Apr. 26, 2005
(86) PCT No.: PCT/JP05/07901

§ 371 Date: Oct. 27, 2006

(30) Foreign Application Priority Data
Apr. 30, 2004 (JP) 2004/135700

(51) Int. Cl. H04L 9/00

(52) U.S. Cl. 705/59

(57) ABSTRACT

There is provided a content use management method capable of preventing unauthorized distribution of a content and improving user-friendliness. In this method, the same group key is stored in a secure device (400) and a playback terminal (500). Moreover, a license issuing application is received from a license distribution server (200) and stored in the secure device (400). After this, a license encrypted by the group key is sent to the playback terminal (500) and the license encrypted by the group key is stored in the playback terminal (500). Upon playback of the encrypted content, the playback terminal (500) decrypts the license by using the group key and acquires the content decryption key, thereby decrypting the encrypted content. Even when the encrypted license flows into the network, it cannot be decrypted by a playback terminal not having the same group key and the copyright is protected. Moreover, the playback terminal (500) which already holds the group key and the license encrypted by the group key does not need the secure device when reproducing the encrypted content.

### TECHNICAL FIELD

The present invention relates to a method of performing digital content distribution while protecting the copyright of digital content such as music and video, a secure device such as an IC card, and apparatuses such so as a mobile phone and server, used in that method, and implements Digital Right Management (DRM) that prevents illegal distribution of digital content while giving consideration to user convenience.

### BACKGROUND ART

In recent years, digital content such as music, video, and books has been widely distributed and sold via the Internet. At the same time, there have been many cases of copyright infringement whereby digital content can be freely downloaded via the Internet without the permission of the copyright holder, and preventing illegal distribution of digital content via a network has become a major concern.

Various methods have been developed to date in order to solve this problem. For example, in Patent Document 1 below a method is described whereby a content key is encrypted with a unique key of a receiving-side apparatus. The receiving-side apparatus receives and stores digital content and a content key that have undergone encryption processing, and when playing back the digital content, decrypts the content key with the unique key of the receiving-side apparatus, and decrypts the encrypted digital content using this content key.

In Patent Document 2 below a content management method is described whereby the number of contents duplicated onto a recording medium is managed by means of a system called “check-in/check-out.” with this system, the number of contents that can be duplicated is set beforehand on a content-by-content basis. In a terminal that performs content duplication, when duplication is ordered, if there is a remaining number in the number of contents that can be duplicated, content encrypted with the content decryption key and the content decryption key encrypted with an encryption key stored in the playback apparatus are recorded onto a recording medium, and the number of contents that can be duplicated is decremented by 1. Also, when content deletion is ordered, the number of contents that can be duplicated is incremented by 1 each time one duplicate content is deleted from the recording medium. Content duplicated onto a recording medium can be played back only by a playback apparatus in which the encryption key used for encryption of the content decryption key is held.

In Patent Document 3 below, a system is described whereby a content distribution center releases encrypted digital content on a network, and sells a license containing the decryption key and usage conditions for this digital content as a digital content usage right. Duplication of encrypted digital content onto a recording medium can be performed freely, but in order to play back this digital content, a license must be purchased separately from a license distribution center. As this license is encrypted using secret information specific to a terminal, the digital content can only be played back by that terminal, and another terminal cannot decrypt the digital content even if it acquires a duplicate of the license.

In Patent Document 4 below, a system is described whereby licensee for digital content of each user are managed by a distribution server. When this content is used, a request is issued to the distribution server from a user terminal. The distribution server confirms the user's contract conditions, and if the user has a usage right, a license containing usage condition information and a content decryption key is distributed to the user terminal.

In Non-patent Document 1 below, a system is described whereby encrypted digital content is distributed as appropriate via a network or the like, and a license containing a decryption key for this content is encrypted and held in a secure device such as an IC card. The license is encrypted with an ID specific to the secure device, and stored in the secure device. Playback of this digital content is made possible by inserting the secure device in which the license is stored into a playback apparatus that has acquired encrypted digital content. As long as a user has this secure device, he or she can use purchased digital content in a plurality of information devices.

Patent Document 1: Unexamined Japanese Patent Publication No. HEI 10-269289

Patent Document 2: Japanese Patent Application Laid-open No. 2000-315177

Patent Document 3: WO 01/063834

Patent Document 4: Japanese Patent Application Laid-Open No. 2003-58660

Non-patent Document 1: “Development of a Digital Copyright Protection Technology Using an SD Card” (Jul. 17, 2003) (http://www.toshiba.co.jp/about/press/2003_{—}07/pr_j1702.htm)

### DISCLOSURE OF INVENTION

### Problems to be Solved by the Invention

However, robust copyright protection reduces user convenience, resulting in a lack of growth in the number of digital content users and sluggish sales.

For example, the systems described in above Patent Documents 1 and 3 are inconvenient in that playback of digital content can only be performed on a specific terminal, so that it is not possible for content used on audiovisual equipment at home to be played back on a mobile terminal away from home, or for a license obtained by a home terminal to be used by a mobile terminal.

With the system described in above Patent Document 2, playing back content on another terminal requires check-out to be performed by carrying out direct communication with the terminal that acquired the content, or content checked-out for a secure device to be inserted in an information device when used. The task of checking-in to the terminal that acquired the content is also necessary.

Demerits of the system described in above Patent Document 4 are that digital content cannot be used in an environment in which the playback terminal cannot be connected to a network, and in the case of a network to which a user is not constantly connected, a communication fee for obtaining a license is generated each time digital content is used.

In contrast, with the system in above Non patent Document 1, as long as there is a secure device holding a license, digital content can be used in a plurality of information devices that have acquired encrypted digital content.

However, with this system, the task of inserting a secure device into an information device must always be carried out when using content, and digital content cannot be used in an information device in which a secure device is not inserted. Consequently, even if a plurality of content licenses are held in a secure device, these contents cannot be played back simultaneously on different information devices.

An inconvenience in a usage scenario in which a music content license is obtained via a mobile phone, and the license is held in a secure device of the mobile phone, is that when music content is played back on an audiovisual device it is necessary to remove the secure device from the mobile phone and insert it in the audiovisual device each time, during which time the functions of the mobile phone that uses the secure device cannot be utilized.

The present invention solves such hitherto extant problems, and it is an object of the present invention to provide a content use management method whereby illegal distribution of digital content via a network can be prevented and a high degree of user convenience can be secured, and also to provide a secure device such as an IC card, and apparatuses such as a mobile phone and server, used in that method.

### Means For Solving The Problems

In a content use management method of the present invention, a group key is stored in a secure device that executes computation in a concealed state and stores data in a concealed state, after which the same group key is stored in the secure device and a playback terminal by sending the group key from the secure device to the playback terminal, and a license issuance application (“application” hereinafter being abbreviated to “app”) that issues a content license is received from a license distribution server and stored in the secure device, after which a license encrypted with the group key is stored in the playback terminal by sending the license encrypted with the group key from the secure device to the playback terminal, and the playback terminal, when using encrypted content, decrypts the license with the group key and extracts a content decryption key contained in the license, and decrypts encrypted content with this decryption key.

### ADVANTAGEOUS EFFECT OF THE INVENTION

According to the present invention, since a content license is held encrypted with a group key, even if a license encrypted with a group key is released onto a network, the license cannot be decrypted by a playback terminal that does not have the same group key, and therefore it is impossible to play back encrypted content illegally, and copyright is protected. Also, if an attempt is made to obtain a license illegally by switching secure devices, a demerit arises associated with group key updating, and such action is also suppressed.

A playback terminal that already holds a group key and a license encrypted with that group key can play back encrypted content even it there is no secure device. Therefore, if a secure device holds a plurality of content licenses, these licenses can be used simultaneously by a plurality of playback terminals of the same group having the same group key.

Also, when content is played back, an operation of inserting a secure device in the playback terminal is unnecessary.

Furthermore, de facto user binding can be achieved by giving a group key to various terminals owned by a user.

Consequently, this method improves user convenience.

A secure device, playback terminal, and license distribution server of the present invention can realize a content use management method of the present invention.

According to the present invention, by having a secure device perform secret communication with another secure device and hold an ID, and store that ID when acquiring a license issuance app from a license distribution server, the license issuance app can be transferred to the other secure device.

### BRIEF DESCRIPTION OF DRAWINGS

FIG. 1 is an overall configuration diagram of a DRM system according to Embodiment 1 of the present invention;

FIG. 2 is a block diagram showing the configuration of a communication terminal and secure device that perform group key generation processing in a DRM system according to Embodiment 1 of the present invention;

FIG. 3 is a flowchart showing the group key generation processing procedure in a DRM system according to Embodiment 1 of the present invention;

FIG. 4 is a drawing showing the GUI at the time of a group key generation request in a DRM system according to Embodiment 1 of the present invention;

FIG. 5 is a drawing showing the data structure of a group key in a DRM system according to Embodiment 1 of the present invention;

FIG. 6 is a block diagram showing the configuration of a playback terminal and secure device that perform group key issuance processing in a DRM system according to Embodiment 1 of the present invention;

FIG. 7 is a flowchart showing the group key issuance processing procedure in a DRM system according to Embodiment 1 of the present invention;

FIG. 8 is a drawing showing the GUI at the time of a group key issuance request in a DRM system according to Embodiment 1 of the present invention;

FIG. 9 is a drawing showing the data structure of a license issuance app in a DRM system according to Embodiment 1 of the present invention;

FIG. 10 is a block diagram showing the configuration of a content distribution server, license distribution server, communication terminal, and secure device that perform license issuance app acquisition processing in a DRM system according to Embodiment 1 of the present invention;

FIG. 11 is a drawing showing the data structure of a license management DB in a DRM system according to Embodiment 1 of the present invention;

FIG. 12 is a flowchart showing the license issuance app acquisition processing procedure in a DRM system according to Embodiment 1 of the present invention;

FIG. 13A is a drawing showing the GUI at the time of a license issuance app acquisition request in a DRM system according to Embodiment 1 of the present invention;

FIG. 13B is a drawing showing the GUI at the time of a license issuance app acquisition request in a DRM system according to Embodiment 1 of the present invention;

FIG. 14 is a block diagram showing the configuration of a playback terminal and secure device that perform license issuance processing in a DRM system according to Embodiment 1 of the present invention;

FIG. 15 is a flowchart showing the license issuance processing procedure in a DRM system according to Embodiment 1 of the present invention;

FIG. 16 is a drawing showing the GUI at the time of a license issuance request in a DRM system according to Embodiment 1 of the present invention;

FIG. 17A is a drawing explaining a group key change in a DRM system according to Embodiment 1 of the present invention;

FIG. 17B is a drawing explaining a group key change in a DRM system according to Embodiment 1 of the present invention;

FIG. 18 is a drawing explaining a card loan in a DRM system according to Embodiment 1 of the present invention;

FIG. 19 is a drawing explaining the acquisition method for card info for proxy acquisition in a DRM system according to Embodiment 2 of the present invention;

FIG. 20 is a drawing explaining proxy acquisition of a license issuance app in a DRM system according to Embodiment 2 of the present invention; and

FIG. 21 is a drawing explaining transfer of a license issuance app in a DRM system according to Embodiment 2 of the present invention.

### BEST MODE FOR CARRYING OUT THE INVENTION

### Embodiment 1

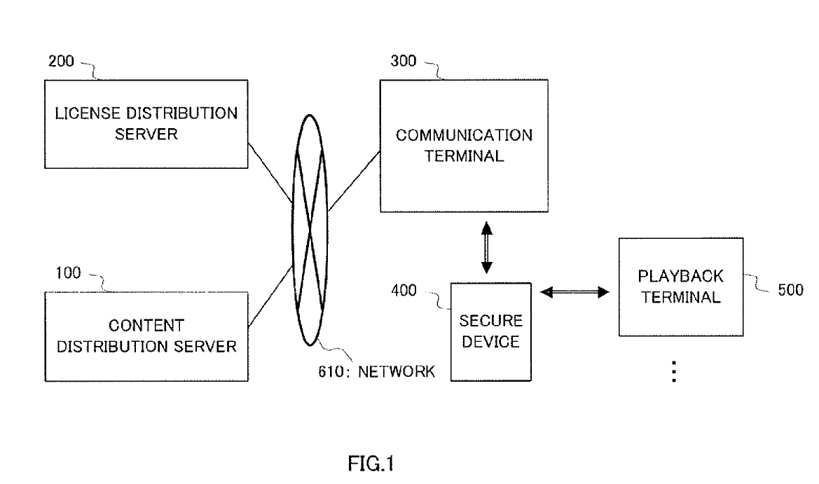

DRM according to the present invention is executed under the system in FIG. 1. This system comprises a content distribution server 100 than encrypts and distributes content, a license distribution server 200 that generates and distributes a license issuance app for license issuance, a communication terminal 300 that accesses license distribution server 200 via a network 610 and receives a license issuance app, a secure device 400 that holds this license issuance app and issues a license, and a playback terminal 500 that acquires encrypted content from content distribution server 100, acquires a license issued by secure device 400, and plays back content.

Content distribution server 100 and license distribution server 200 may be the same information processing apparatus, and communication terminal 300 and playback terminal 500 may be the same information processing apparatus.

Content distribution server 100 encrypts digital content and releases this digital content onto the Internet. License distribution server 200 generates and distributes a license issuance app for digital content distributed from content distribution server 100. This license issuance app contains license information for each format of content provided in various formats.

Communication terminal 300 is an information processing apparatus such as a mobile phone into which secure device 400 can be inserted. Communication terminal 300 communicates with license distribution server 200 and receives a license issuance app, and stores this in secure device 400.

Secure device 400 has a tamper-resistant module section that executes computations in a concealed state and a secure storage area that stores data in a concealed state, and stores a license issuance app acquired from license distribution server 200 in the secure storage area.

Playback terminal 500 has an encrypted content storage section, and holds encrypted content acquired from content distribution server 100. This acquisition may be performed by playback terminal 500 itself via network 610, may be performed via communication terminal 300, may be performed via communication terminal 300, or may be performed via a recording medium such as a CD. The acquisition method is immaterial.

Playback terminal 500 allows insertion of secure device 400, and when secure device 400 is inserted, holds the license issued by secure device 400 in the storage section. Playback terminal 500 holding encrypted content and a license can decrypt and play back content even when secure device 400 is not inserted.

However, playback terminal 500 to which secure device 400 issues a license is restricted to a playback terminal 500 to which a group key has been passed from secure device 400 beforehand.

Therefore, the following kind of procedure is necessary in order to enable content to be played back by a plurality of terminal apparatuses (playback apparatuses) owned by a user.

(1) Secure device 400 is inserted into communication terminal 300, and a group key is set in secure device 400 from the input section of communication terminal 300 (group key generation processing).

(2) Secure device 400 holding the group key is inserted into the user's plurality of playback terminals 500, the group key is passed from secure device 400, and is stored in each playback terminal 500 (group key issuance processing).

(3) License distribution server 200 is accessed by communication terminal 300 in which secure device 400 is inserted, and a license issuance app is received from license distribution server 200 and stored in secure device 400 (license issuance app acquisition processing).

(4) Secure device 400 is inserted into playback terminal 500 holding the group key, and the license for encrypted content stored in playback terminal 500 is issued from secure device 400 and stored in playback terminal 500 (license issuance processing).

Each of these processing procedures (1) through (4) is independent. However, a condition of “group key issuance processing” is that a group key generated by “group key generation processing” is held by secure device 400, and a condition of “license issuance processing” is that secure device 400 has acquired a license issuance app by means of “license issuance app acquisition processing.”

These processing procedures will now be described in detail.

(Group Key Generation Processing)

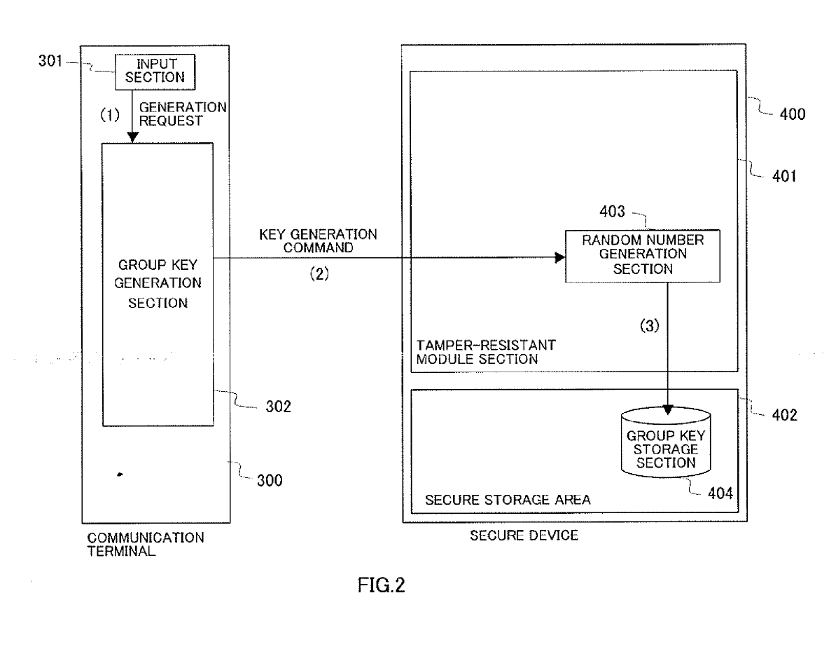

FIG. 2 shows function blocks relating to group key genera-ion processing in communication terminal 300 and secure device 400. Communication terminal 300 has an input section 301 such as a keyboard or mouse, and a group key generation section 302 that orders group key generation. In secure device 400, a random number generation section 403 that generates a random number used as a group key is provided in tamper-resistant module section 401, and a group key storage section 404 that stores a group key is provided in secure storage area 402.

Random number generation section 403 is implemented by operations according to a program of the CPU (not shown) of secure device 400.

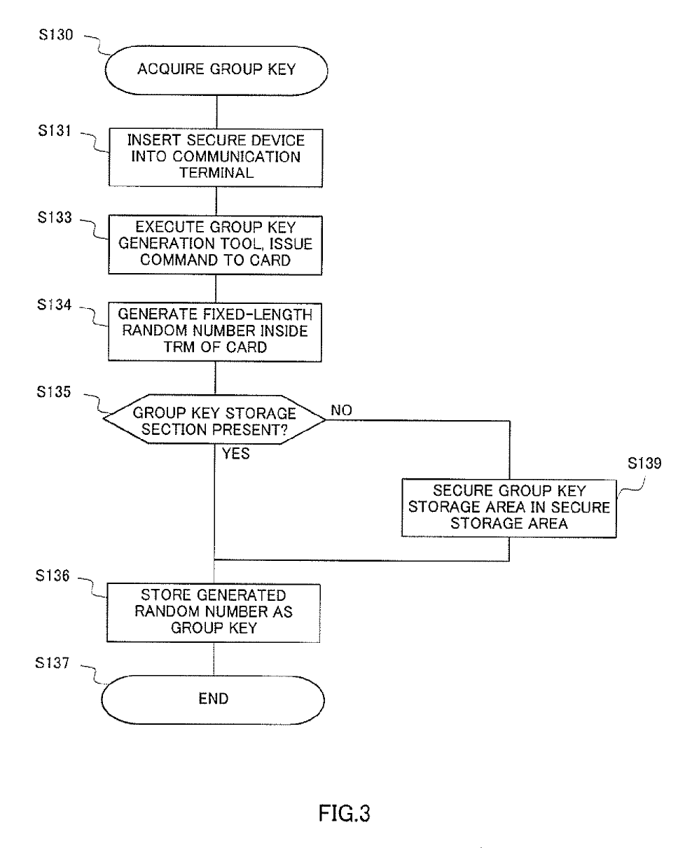

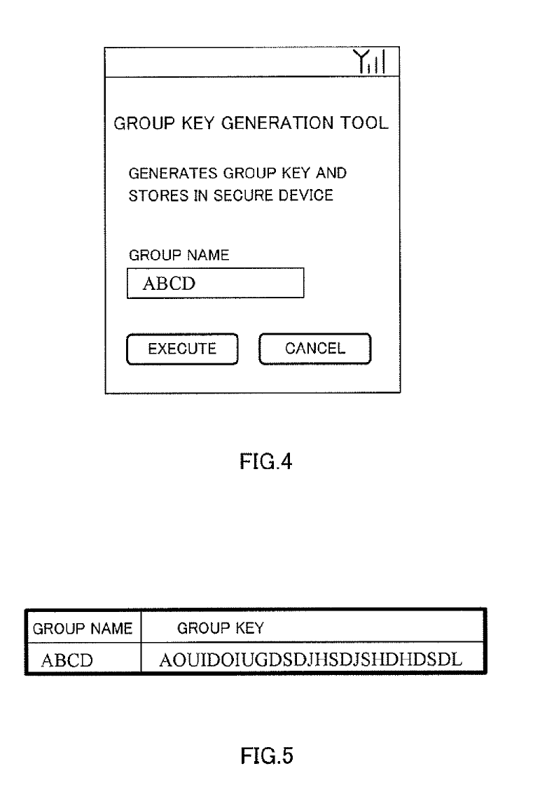

FIG. 3 shows the group key generation processing procedure. When the user inserts secure device 400 into communication terminal 300 (S131) and requests group key generation from input section 301 ((1) in FIG. 2), group key generation section 302 displays the GUI (Graphical User Interface) shown in FIG. 4, for example, on the screen of communication terminal 300. When the user inputs a group name and selects execution, group key generation section 302 that received the group key generation request issues a key generation command to secure device 400 ((2) in FIG. 2) (S133).

When secure device 400 receives the key generation command, random number generation section 403 generates a fixed-length random number as a group key (S134). Group key storage section 404 confirms whether or not there is an area for storing the group key in secure storage area 402 (S135), and it there is not, secures a group key storage area in secure storage area 402 (S139), and records the group key received from random number generation section 403 ((3) in FIG. 2) (S139).

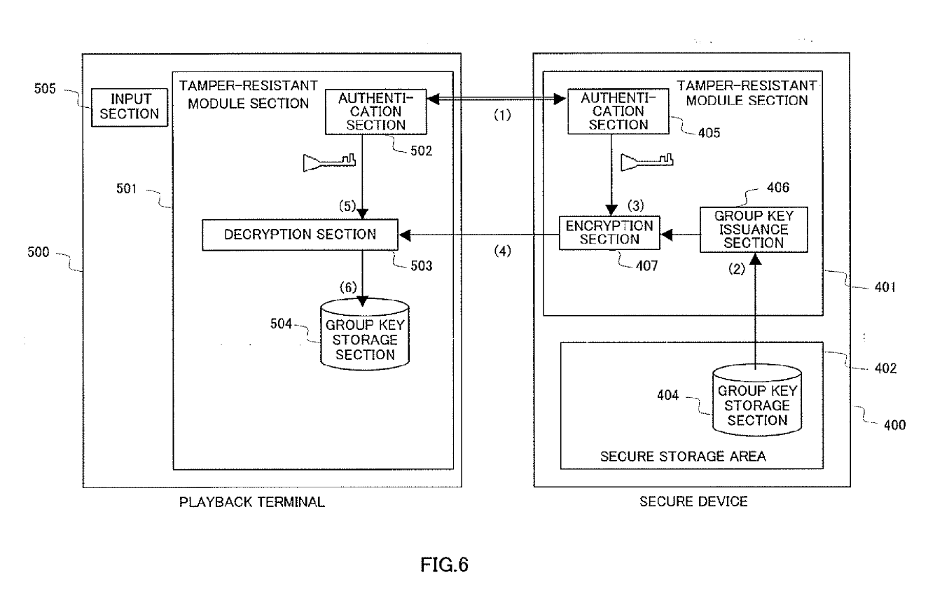

As shown in FIG. 5, the group key is stored together with the group name.

If a group key storage area already exists in S135, group key storage section 404 overwrites the group key recorded in that area with the group key generated in S134 (S139). Thus, only one group key is held in secure device 400.

(Group Key Issuance Processing)

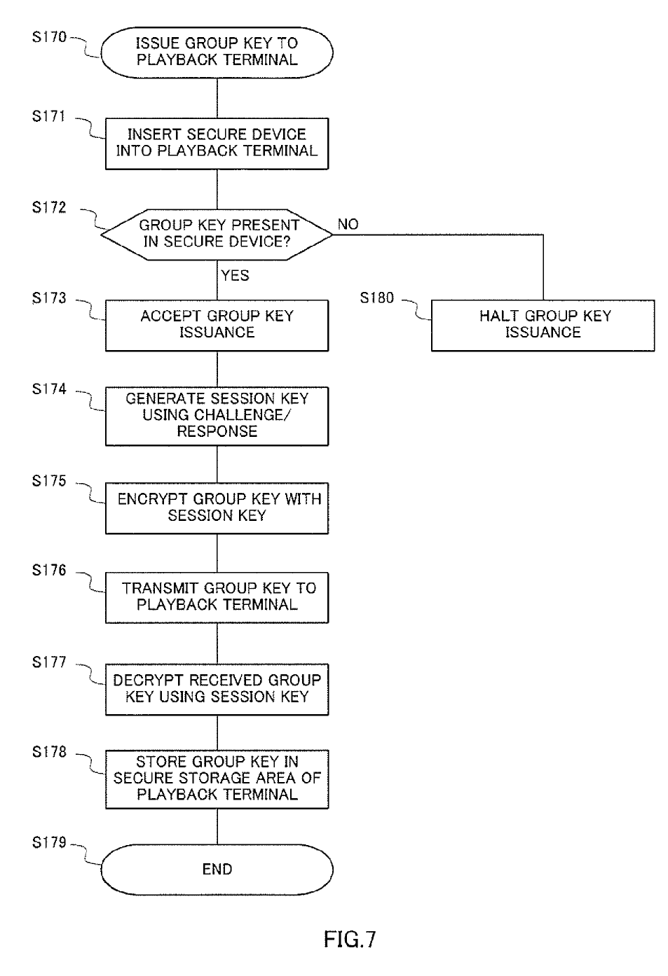

FIG. 6 shows function blocks relating to group key issuance processing in secure device 400 and playback terminal 300. In secure device 400, group key storage section 404 that stores a group key is provided in secure storage area 402, while tamper-resistant module section 401 includes an authentication section 405 that authenticates communication terminal 300, a group key issuance section 406 that issue a group key, and an encryption section 407 that encrypts a group key.

Group key issuance section 406, authentication section 405, and encryption section 407 are implemented by operations according to a program of the CPU (not shown) of secure device 400.

Playback terminal 500 has an input section 505 that inputs a group key issuance request, and a tamper-resistant module section 501 includes an authentication section 502 that authenticates secure device 400, a decryption section 503 that decrypts an encrypted group key, and a group key storage section 504 that stores a group key.

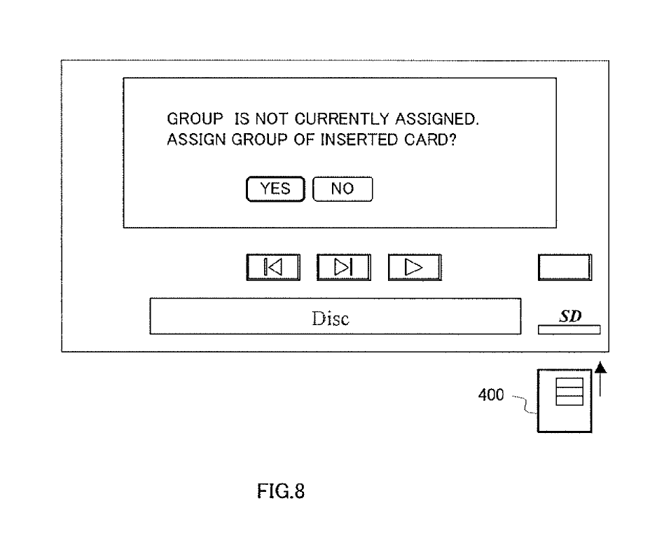

FIG. 7 shows the group key issuance processing procedure.

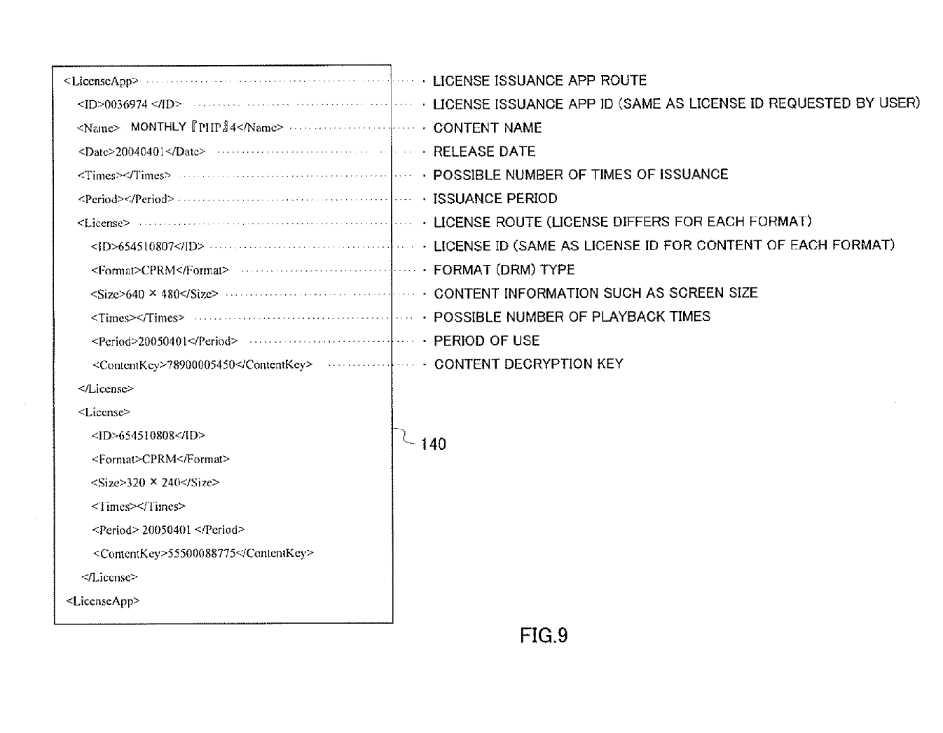

The user inserts secure device 400 into playback terminal 500 (S171) and requests group key issuance from input section 505. This group key issuance request is performed, for example, by selecting “Yes” from the GUI display shown in FIG. 8.

On receiving this request, secure device 400 confirms whether a group key is stored (S172), and it a group key is not stored, halts group key issuance (S180). If a group key is stored, secure device 400 accepts group key issuance (S173), mutual authentication is performed between authentication section 405 of secure device 400 and authentication section 502 of playback terminal 500 by means of a typical challenge/response method or the like, and a session key is generated ((1) in FIG. 6) (S174).

Group key issuance section 406 of secure device 400 extracts the group key stored in secure storage area 402 ((2) in FIG. 6), and encryption section 407 encrypts this group key with the session key (3) in FIG. 6) (S175). The encrypted group key is transmitted to playback terminal 500 ((4) in FIG. 6) (S176). Decryption section 503 of playback terminal 500 decrypts the group key using the session key ((5) in FIG. 6) (S177). The decrypted group key is stored in a concealed state by group key storage section 504 ((6) in FIG. 6) (S178).

There is only one group key stored by group key storage section 504 of playback terminal 500. To change the group key of playback terminal 500, the above-described group key issuance processing (FIG. 7) is executed again. As a result, the pre-change group key is overwritten with a new group key by group key storage section 504.

(License Issuance App Acquisition Processing)

A license is usage right data for using target content, and comprises an encrypted content decryption key and usage condition (Usage Rule) data. The usage rules stipulate the period for which content can be used, the number of times it can be used, and so forth, and content can be decrypted and utilized using a decryption key included in a license only within the scope of those rules.

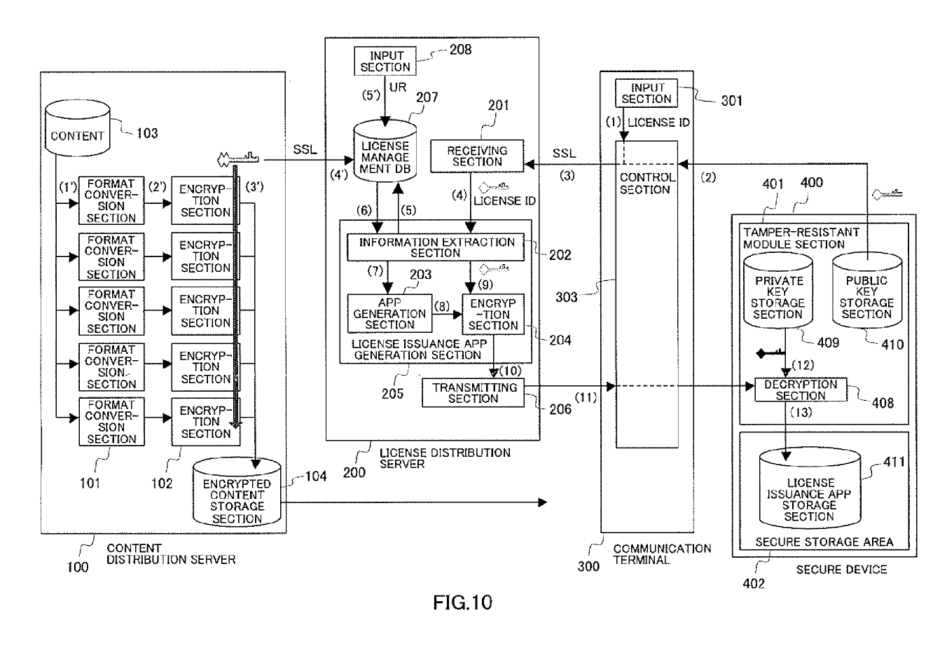

A license issuance app comprises an execution program for creating a license according to different content formats (DRM format, screen size, and so forth) of the same content, and packaged data used in creating this license. As shown in FIG. 9, this data includes usage rules for the license issuance app itself (possible number of times of issuance, issuance period, and so forth) and the content format, usage rules; decryption key, and so forth for each license.

The execution program is a program for analyzing a content profile containing content information adaptable by a playback terminal, extracting necessary information from the packaged data, and creating a license suitable for the type of content format.

In license issuance app acquisition processing, processing is performed whereby a request for this license issuance app is made to license distribution server 200, and a license issuance app obtained from license distribution server 200 is stored in the secure storage area of secure device 400 in a concealed state.

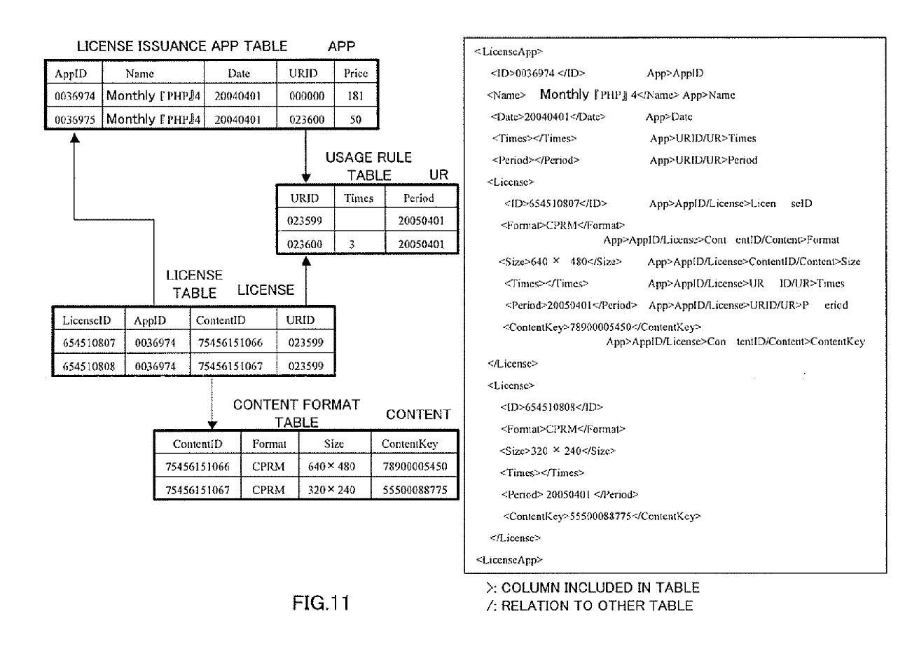

FIG. 10 shows function blocks relating to license issuance app acquisition processing in content distribution server 100, license distribution server 200, communication terminal 300, and secure device 400.

Content distribution server 100 is equipped with content 103, a format conversion section 101 that performs various kinds of conversion of the format of content 103, an encryption section 102 that encrypts content whose format has been converted, and an encrypted content storage section 104 that stores encrypted content.

License distribution server 200 is equipped with a license management database (DB) 207 that records information necessary for license issuance, an input section 208 that inputs information such as usage rules, a receiving section 201 that receives a license acquisition request from communication terminal 300, a license issuance app generation section 205 that generates a license issuance app according to a license acquisition request, and a transmitting section 206 that transmits a generated license issuance app. License issuance app generation section 205 includes an information extraction section 202 that extracts necessary information from license management DB 207 according to a license acquisition request, an app generation section 203 that generates a license issuance app using extracted information, and an encryption section 204 that encrypts a generated license issuance app with a public key of secure device 400.

Communication terminal 300 is equipped with an input section 301 to which a license acquisition request is input, and a control section 303 that mediates communications between secure device 400 and license distribution server 200 for implementing license issuance app acquisition.

Secure device 400 is equipped with a public key storage section 410 that stores a public key of secure device 400, a private key storage section 409 that stores a private key of secure device 409, a decryption section 408 that decrypts an encrypted license issuance app using the private key, and a license issuance app storage section 411 that stores a decrypted license issuance app.

Decryption section 408 is implemented by operations according to a program of the CPU (not shown) of secure device 400.

In content distribution server 100, content 103 is converted to various types of format by format conversion section 101 ((1′) in FIG. 10), encrypted by encryption section 102 ((2′) in FIG. 10), and stored in encrypted content storage section 104 ((3′) in FIG. 10).

Stored encrypted content is recorded on media such as a CD and distributed, or released onto the Internet, or else distributed in a P2P or similar mode. Playback terminal 500 acquires encrypted content disseminated using these distribution modes.

A key used for content encryption (content decryption key) is sent to license distribution server 200 by means of secure communication such as SSL, and recorded in license management DP 207 ((4′) in FIG. 10). Information such as usage rules is input from input section 208, and recorded in license management DB 207 ((5′) in FIG. 10).

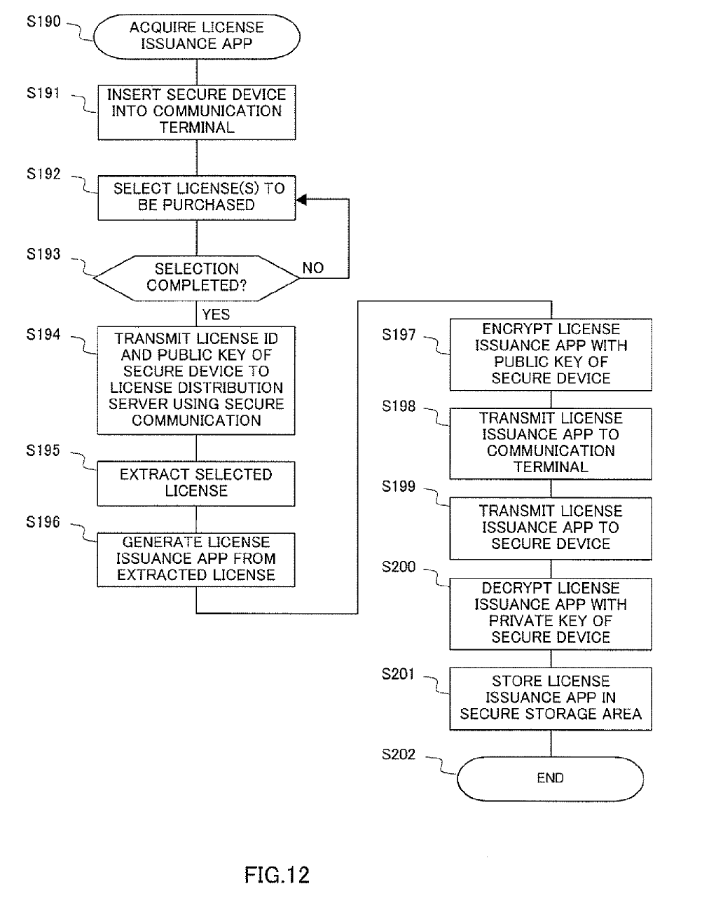

Thus, information necessary for generation of a license for each content is collected and managed in license management DB 207 of license distribution server 200, FIG. 11 shows an example of the license management DB 207 license information management mode, showing a case in which license information is managed by associating a “license issuance app table,” “license table,” “usage rule table,” and “content format table.” The “license issuance app table” contains a “license issuance app ID” (AppID: the same as the license ID requested by the user), the content name, data indicating the release date, “URID” indicating the usage rules of the license issuance app itself, and the sales price. The “license table” shows the relationship between “AppID,” “LicenseID” for each content format, “ContentID” indicating the format, and “URID” indicating the usage rules of a license of each format. The “usage rule table” contains the contents of the usage rules corresponding to “URID.” The “content format table” contains a DRM format, screen size, and content decryption key as contents of a content format corresponding to “ContentID.”

Execution of license issuance app acquisition processing is made possible by recording license information in license management DB 207 of license distribution server 200 in this way.

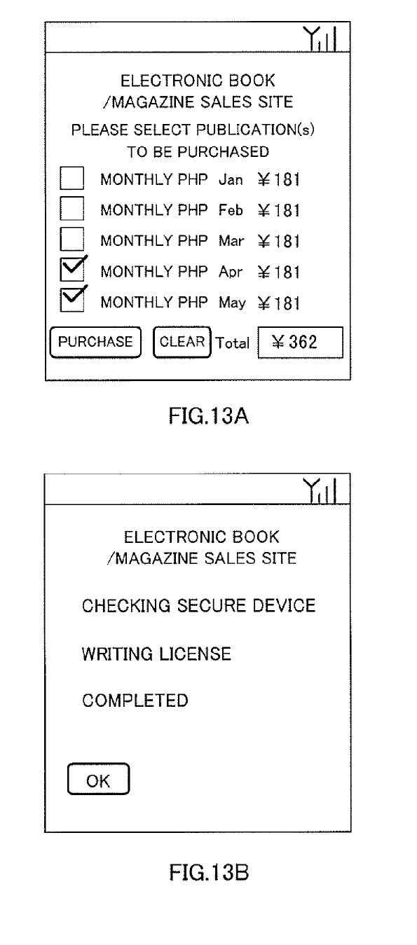

FIG. 12 shows the license issuance app acquisition processing procedure.

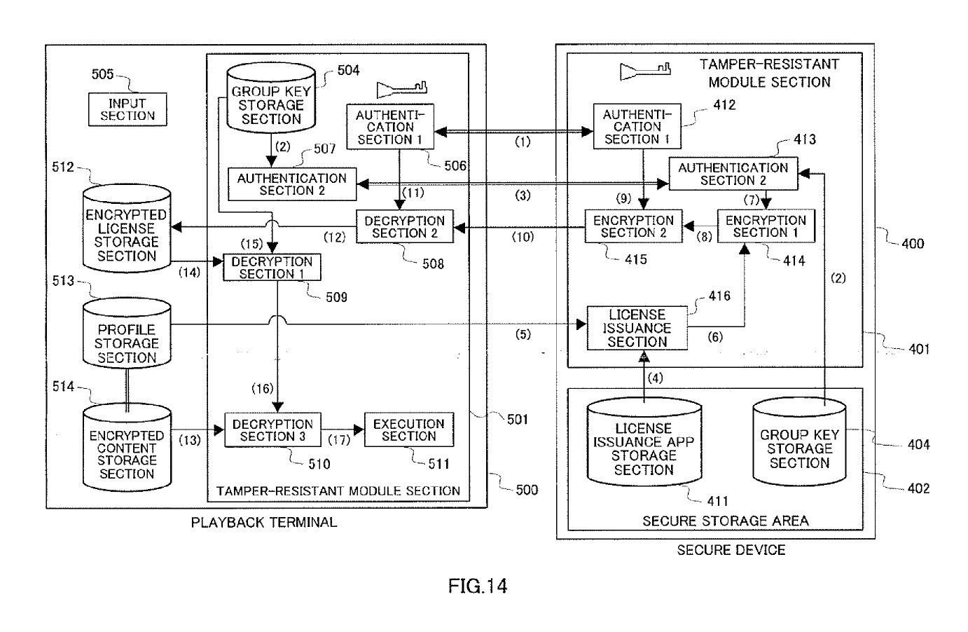

The user inserts secure device 400 into communication terminal 300 (S191), and requests license issuance app acquisition from input section 301 of communication terminal 300. At this time, license distribution server 200 supplies the screen shown in FIG. 13A, for example, to communication terminal 300. The user enters a check mark in the check box for a license item to be acquired on the screen, then presses the Purchase button, and selects a license to be purchased ((1) in FIG. 10) (S192, S193).

When a license to be purchased is selected, communication terminal 300 acquires the public key of secure device 400 held by public key storage section 413 of inserted secure device 400 ((2) in FIG. 10), and transmits this to license distribution server 200 together with the ID of the license selected by the user, using secure communication such as SSL ((3) in FIG. 10) (S194).

These items of information are received by receiving section 201 of license distribution server 200, and are passed to license issuance app generation section 205 ((4) in FIG. 10). In license issuance app generation section 205, information extraction section 202 extracts data necessary for license issuance app generation from license management DB 207 based on the ID of the license selected by the user ((5) and (6) in FIG. 10) (S195). App generation section 203 generates a license of each format based on the extracted data, and packages these and generates a license issuance app ((7) in FIG. 10) (S196). Encryption section 204 encrypts this license issuance app with the public key of secure device 400 ((8) and (9) in FIG. 10) (S197). The encrypted license issuance app is sent to communication terminal 300 by transmitting section 206 ((10) and (11) in FIG. 10) (S198), and is passed to secure device 400 (S199). Decryption section 408 of secure device 400 decrypts the encrypted license issuance app using the private key held in private key storage section 409 ((12) in FIG. 10) (S200). The decrypted license issuance app is stored in secure storage area 402 by license issuance app storage section 411 ((13) in FIG. 10) (S201).

At this time, license distribution server 200 supplies the screen shown in FIG. 13B, for example, to communication terminal 300, and notifies the user that the license issuance app has been stored in secure device 400.

License distribution server 200 and the server that actually sells a license need not be the same. Processing relating to license selling is outside the scope of the present invention, and is not discussed in detail here.

(License Issuance Processing)

In license issuance processing, processing is performed whereby secure device 400 is inserted into playback terminal 500, a license issuance app stored in a secure area of secure device 400 is executed, and a license is issued to playback terminal 500.

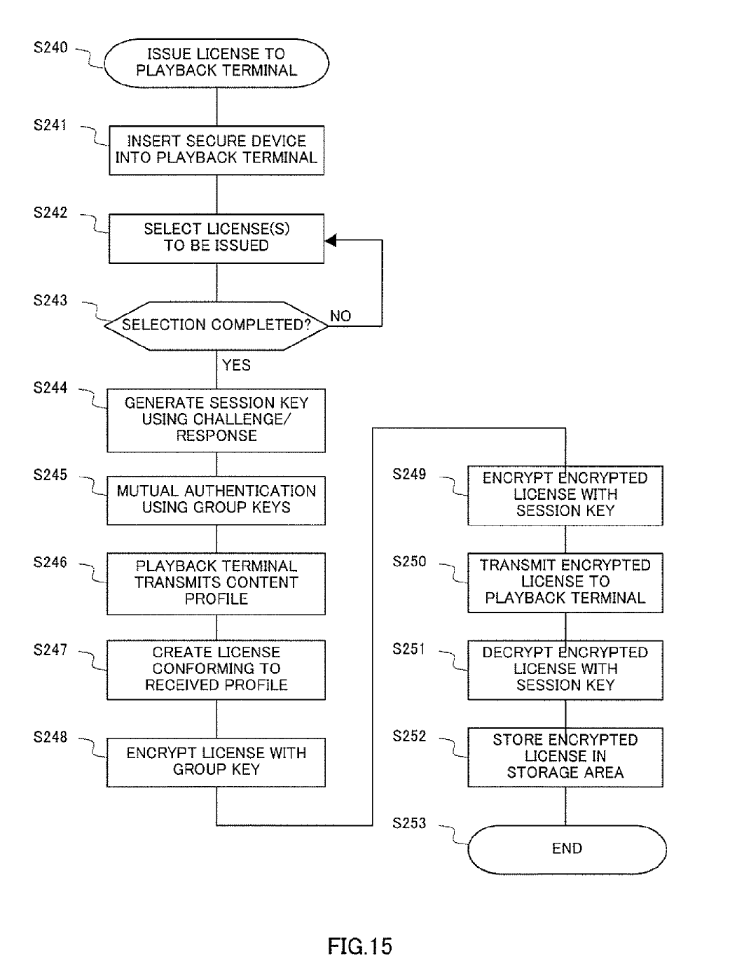

FIG. 14 shows function blocks relating to license issuance app acquisition processing in secure device 400 and playback terminal 500.

In secure device 400, secure storage area 402 has group key storage section 404 that stores a group key and license issuance app storage section 411 that stores a license issuance app, and tamper-resistant module section 401 has a first authentication section 412 that performs mutual authentication with playback terminal 500, a second authentication section 413 that authenticates having the same group key as playback terminal 500, a license issuance section 416 that issues a license to playback terminal 500 using a license issuance app, a first encryption section 414 that encrypts the issued license with the group key, and a second encryption section 415 that encrypts the license encrypted with the group key with a session key.

First authentication section 412, second authentication section 413, first encryption section 414, second encryption section 415, and license issuance section 416 are implemented by operations according to a program of the CPU (not shown) of secure device 400.

Playback terminal 500 has input section 505 that inputs a license issuance request, an encrypted content storage section 514 that stores encrypted content, a profile storage section 513 that stores a profile including DRM format, screen size, and so forth of content that can be used in playback terminal 500, and an encrypted license storage section 512 that stores a license encrypted with a group key, and tamper-resistant module section 501 includes group key storage section 504 that stores a group key, a first authentication section 506 that performs mutual authentication with secure device 400, a second authentication section 507 that authenticates having the same group key as secure device 400, a second decryption section 508 that decrypts an encrypted license sent from secure device 400 with a session key, a first decryption section 509 that uses a group key to decrypt an encrypted license read from encrypted license storage section 512 at the time of content playback, a third decryption section 510 that decrypts encrypted content read from encrypted content storage section 514, and an execution section 511 that plays back content in accordance with usage rules stipulated by the license.

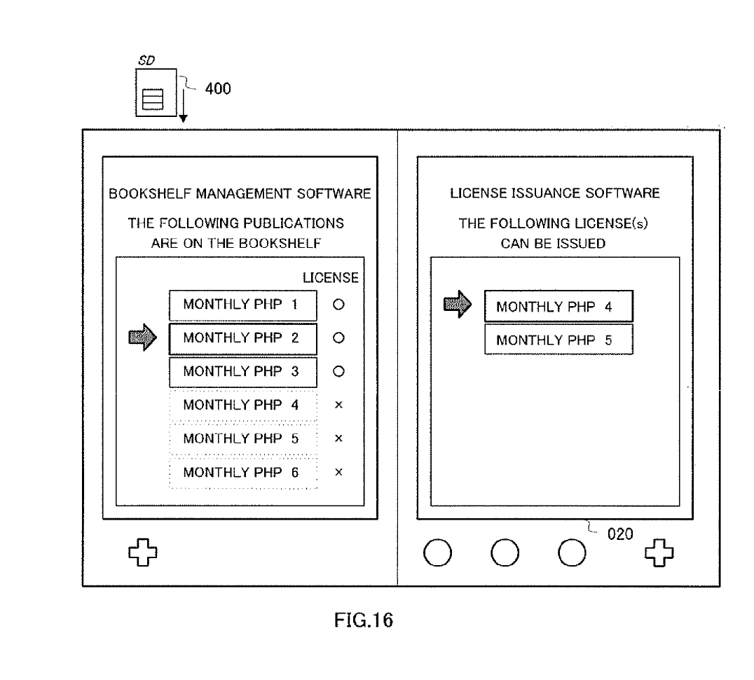

FIG. 15 shows the license issuance processing procedure.

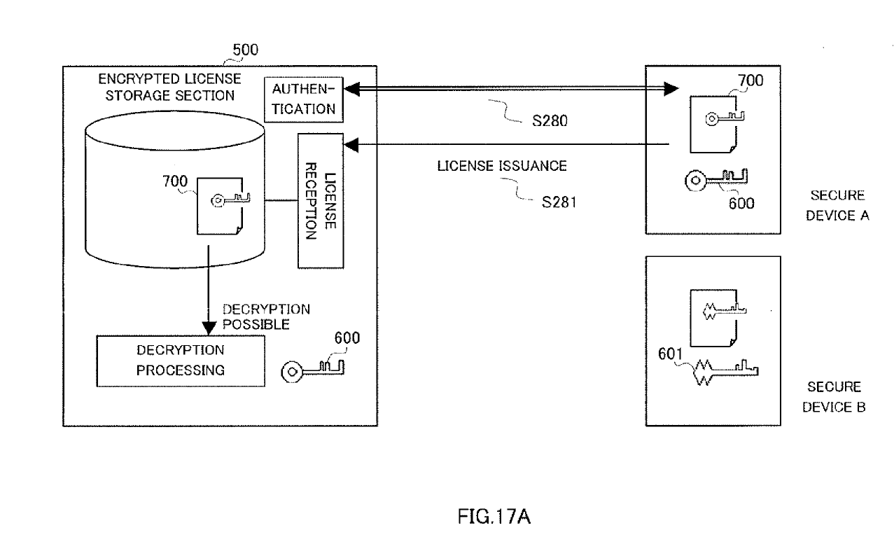

The user inserts secure device 400 into playback terminal 500 (S241), and selects a license to be issued via input section 505 (S241, S242). At this timer usability can be improved by displaying the GUI shown in FIG. 16, for example, on playback terminal 500. On the left side of this screen, the names of content stored in encrypted content storage section 514 are listed, of which content for which a license is stored in encrypted license storage section 512 is indicated by a o symbol, and content for which a license is not stored is indicated by a x symbol. On the right side of the screen, content is listed for which a license can be issued by means of secure device 400. To playback content, the user selects content with a o symbol under the “License” heading on the left side by means of input section 505, and to request issuance of a license, the user selects the name of content on the right side by means of input section 505.

When a license to be issued is selected and the relevant information is sent to secure device 400, mutual authentication is performed between first authentication section 412 of secure device 400 and first authentication section 506 of playback terminal 500 by means of a typical challenge/response method or the like, and a session key is generated ((1) in FIG. 14) (S244). Then second authentication section 413 of secure device 400 and second authentication section 507 of playback terminal 500 read the group keys stored in group key storage section 404 of secure device 400 and group key storage section 504 of playback terminal 500 respectively ((2) in FIG. 14), and perform mutual authentication using the group keys ((3) in FIG. 14) (S245). If both have the same group key, authentication is successful, whereas if the two have different group keys, authentication is unsuccessful and processing is terminated.

If authentication using the group keys is successful, license issuance section 416 of secure device 400 extracts a license issuance app for the selected content from license issuance app storage section 411 ((4) in FIG. 14). On the other hand, playback terminal 500 transmits to license issuance section 416 of secure device 400 a profile of content adaptable by playback terminal 500 stored in profile storage section 513 ((5) in FIG. 14) (S246). License issuance section 416 analyzes the received profile in accordance with the license issuance app execution program, extracts license creation data for a content format adaptable in playback terminal 500 from license issuance app package data, and creates a license conforming to that received profile (S247). First encryption section 414 encrypts the created license with the group key ((G) and (7) in FIG. 14) (S248), and second encryption section 415 encrypts the license encrypted by first encryption section 414 with a session key ((8) and (9) in FIG. 14) (S249). The license on which double encryption has been performed is transmitted to playback terminal 500 ((10) in FIG. 14) (S250).

When the doubly-encrypted license is received by playback terminal 500, second decryption section 508 decrypts the doubly-encrypted license using the session key ((11) in FIG. 14) (S251) and the license encrypted with the group key is stored in encrypted license storage section 512 ((12) in FIG. 14) (S252).

Content playback is performed by means of the following procedure.

Content is stored in its encrypted state in encrypted content storage section 514, and a license containing the content decryption key is encrypted with the group key and stored in encrypted license storage section 512.

In content playback, first decryption section 509 acquires the group key from group key storage section 504 ((15) in FIG. 14), and decrypts the encrypted license stored in encrypted license storage section 512 ((14) in FIG. 14). The decrypted license is sent to third decryption section 510 ((16) in FIG. 14), and, using the decryption key contained in the license, third decryption section 510 decrypts the encrypted content stored in encrypted content storage section 514 ((17) in FIG. 14) Execution section 511 plays back the decrypted content within the scope of the usage rules of the license.

Here, a case has been described in which a license issuance app distributed to a secure device contains an execution program that creates a license in accordance with the content format, and packaged data, but this data and execution program may also be separated, with the execution program being stored in a secure area of a secure device beforehand, and only data being distributed as a license issuance app. In this mode, when the secure device issues a license, license issuance processing is performed with the execution program reading a data only license issuance app.

If playback terminal 500 of a DRM system of the present invention acquires a group key by means of group key issuance processing and acquires an encrypted license by means of license issuance app acquisition processing in this way, when subsequently playing back encrypted content, playback terminal 500 can decrypt the encrypted license with the group key and extract a content decryption key, and can thus play back encrypted content without a secure device being inserted.

Conversely, if playback terminal 500 does not have a group key, or if playback terminal 500 has a group key but the encrypted license has been encrypted with a different group key, playback terminal 500 cannot play back the encrypted content.

Therefore, even if an encrypted license is distributed illegally via a network, a playback terminal that acquires that encrypted license via the network cannot playback encrypted content, and content copyright is protected.

Also, although there are few cases of copyright violation through switching of secure devices compared with illegal use of content via a network, a DRM system of the present invention also has an effect: of suppressing this kind of copyright violation. With the system described in Non-patent Document 1 above where by a content decryption key is encrypted and held in a secure device, playback of encrypted content is possible both when the actual secure device in which the content decryption key is stored is inserted into the actual playback terminal in which encrypted content is stored, and when another person's secure device in which the content decryption key is stored is borrowed and inserted, whereas with a playback terminal of a DRM system of the present invention, if another person's secure device is borrowed and the group key is updated, and an encrypted license is acquired from that secure device, there is a demerit of no longer being able to use the encrypted license acquired from the original secure device, and the copyright protection contrivance of the present invention acts to suppress illegal switching of secure devices.

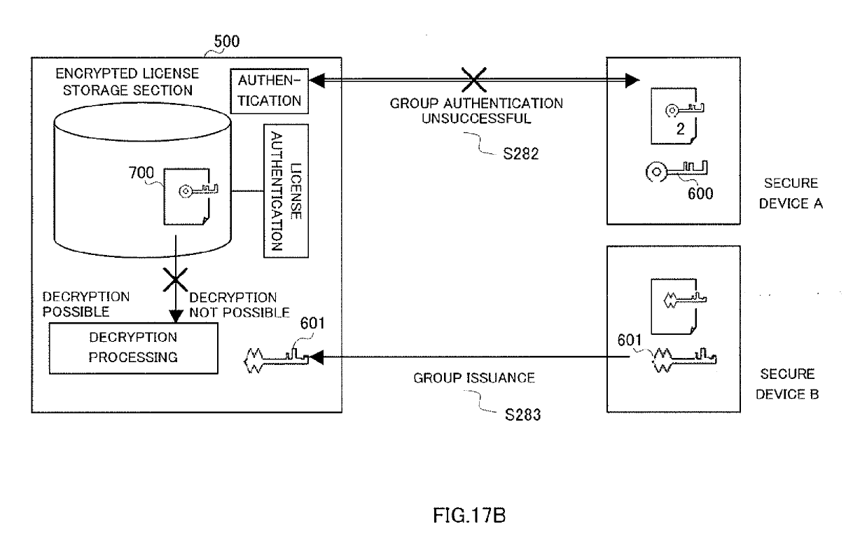

FIGS. 17A and 17D are drawings that explain this point.

As shown in FIG. 17A, when playback terminal 500 holds a group key 600 issued from a secure device A, secure device A and playback terminal 500 can perform mutual authentication using group key 600 (S280), an encrypted license 700 can be issued to playback terminal 500 from secure device A (S261), and playback terminal 500 can decrypt this encrypted license 700 with group key 600, and extract an encrypted content decryption key from the license.

However, as shown in FIG. 17B, when a group key held by playback terminal 500 is updated to a group key 601 issued from a secured device B (S283), encrypted license 700 issued by secure device A, held by playback terminal 500, can no longer be decrypted. Also, even if an attempt is made to issue encrypted license 700 stored in secure device A to playback terminal 500, mutual authentication is unsuccessful since the group keys of secure device A and playback terminal 500 are different (S282), and encrypted license 700 cannot be issued to playback terminal 500.

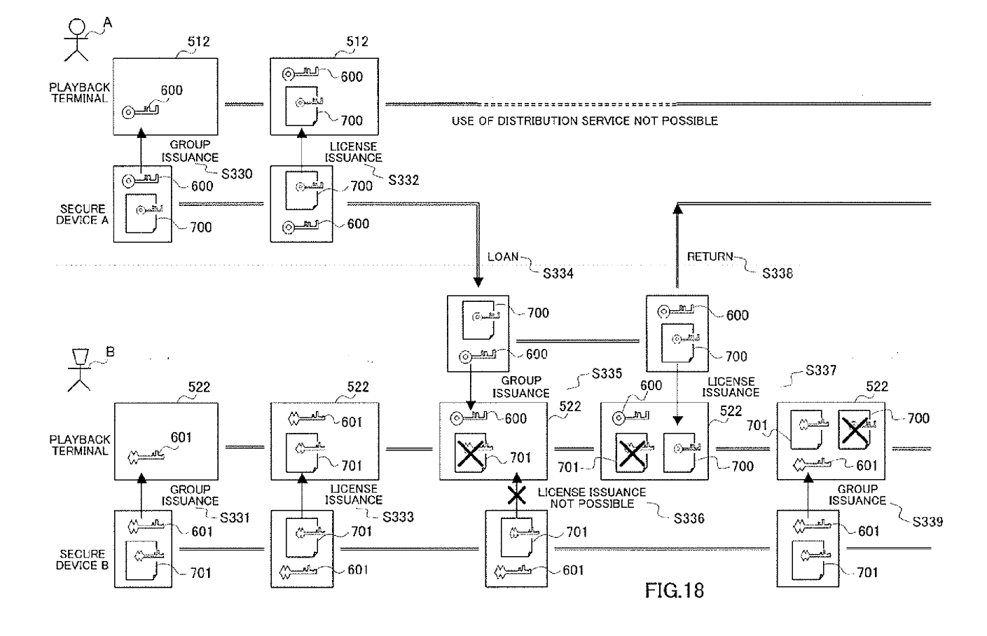

FIG. 18 shows an example in which a playback terminal group key is changed more frequently.

Mr. A issues group key 600 to his own playback terminal 521 using his secure device A (S330), and then issues license 700 (S332). Similarly, Mr. B issues group key 601 to his own playback terminal 522 using his secure device B (S331), and then issues a license 701 (S333).

Mr. A now lends secure device A to Mr. B (S334). While secure device is being lent to Mr. B, Mr. A can no longer acquire a license issuance app from a license distribution server and issue a license.

Mr. B issues group key 600 to playback terminal 522 using secure device A (S335). As a result, Mr. B can no longer use previously issued license 701. Also, even if an attempt is made to issue license 701 to playback terminal 522 using secure device B, issuance is not possible since the group key is different (S336). Mr. B issues license 700 to playback terminal 522 using secure device A (S337). This license 700 can be decrypted by means of group key 600 held by playback terminal 522, and used.

Mr. B returns secure device A to Mr. A (S338). Mr. B issues group key 601 to playback terminal 522 using his originally owned secure device B (S339). When this is done, license 700 issued by secure device A borrowed from Mr. A can no longer be used. However, it becomes possible for license 701 previously issued by secure device B to be used again.

When a group key is changed frequently in this way, there is a demerit of no longer being able to use a previously acquired license, and therefore a user action of attempting to acquire a license illegally by borrowing a secure device from another person is suppressed.

### Embodiment 2

In this embodiment, a case is described in which, in a DRM system, licenses for a plurality of persons are purchased as a set using a secure device, and these licenses are transferred to a secure device held by another person (proxy acquisition).

Proxy acquisition is based on the three procedures described below. The first procedure is card information acquisition, the second procedure is proxy acquisition of a license issuance app, and the third procedure is license issuance app transfer.

(Card Information Acquisition)

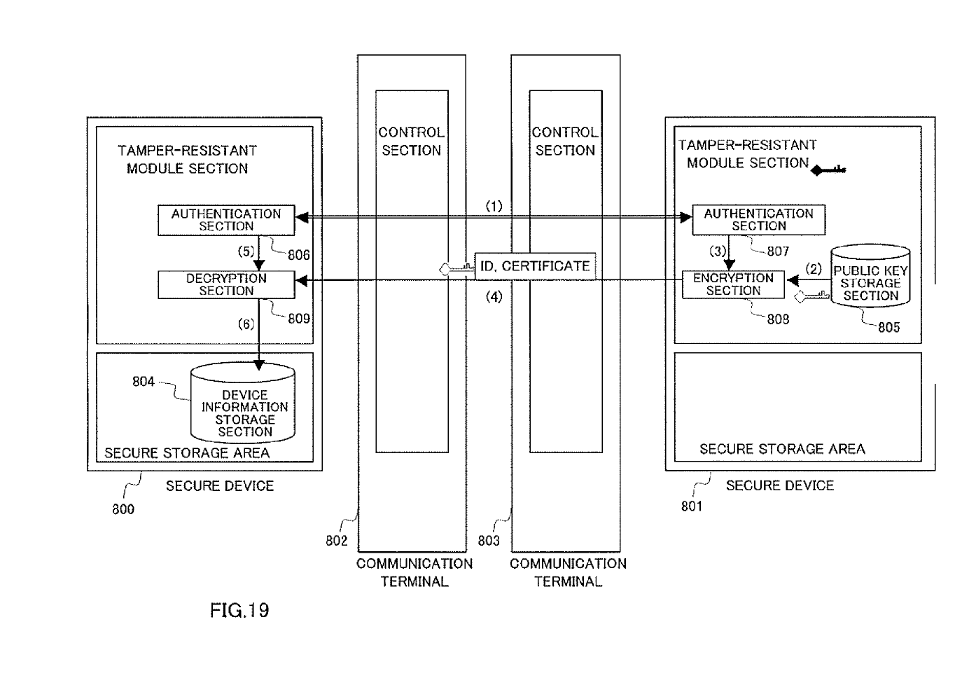

This will be explained using FIG. 19. A secure device 800 and a secure device 801 perform communication using an information terminal with two card slots or information terminals with the respective secure devices inserted, and the fact that these are legal devices is authenticated by authentication sections 806 and 807 ((1) in FIG. 19). When authentication is successful, an encryption section 808 in secure device 801 encrypts a public key stored in a public key storage section 805 with a session key ((2) and (3) in FIG. 19), and transmits this to secure device 800 ((4) in FIG. 19).

In secure device 800, a decryption section 809 decrypts the acquired information with a session key generated by authentication section 806 (5) in FIG. 19) and stores this information in a device information storage section 804 ((6) in FIG. 19).

(Proxy Acquisition of License Issuance App)

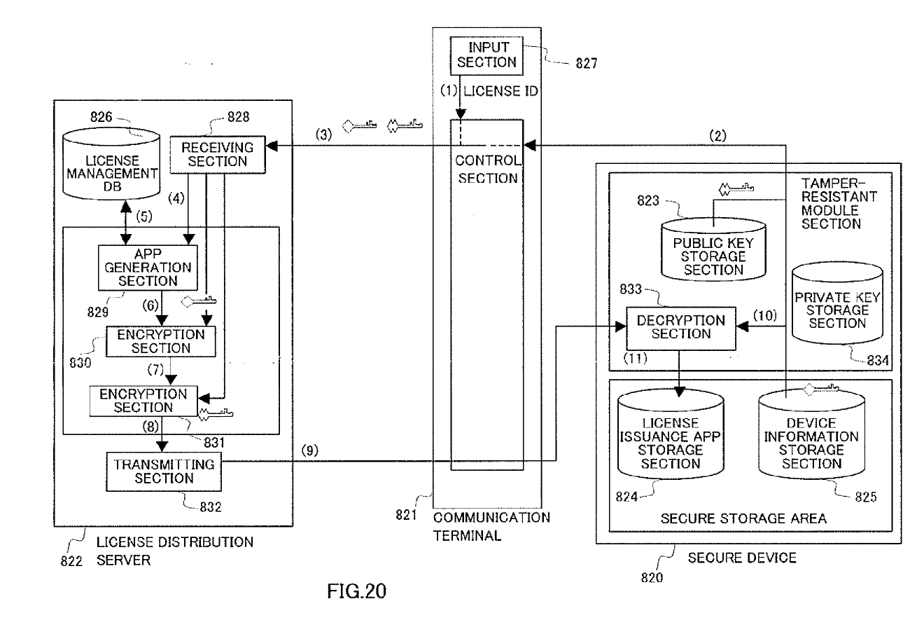

This will be explained using FIG. 20. A secure device 820 is secure device 800 storing information from above-described secure device 801.

Proxy acquisition is also performed in a similar way to above-described license issuance app acquisition processing, but in proxy acquisition, it is necessary for the license distribution server to be provided with an encryption section 830 that encrypts a license issuance app with the public key of the proxy secure device.

When the user selects a license he or she wishes to acquire, a communication terminal 821 acquires the public key of secure device 820 held in a public key storage section 823 of inserted secure device 820, and device information of above-described secure device 801 stored in a device information storage section 825 ((2) in FIG. 20) and transmits this to license distribution server 822 together with the ID of the license selected by the user, using secure communication such as SSL ((3) in FIG. 20).

These items of information are received by a receiving section 828 of license distribution server 822. Then an app generation section 829 extracts data necessary for license issuance app generation from a license management DB 826 based on the ID of the license selected by the user ((5) in FIG. 20), and generates a license issuance app. Encryption section 830 encrypts this license issuance app with the public key of above-described secure device 801. The encrypted license issuance app is further encrypted by an encryption section 831 using the public key of secure device 820 (above-described secure device 800), is sent to communication terminal 821 by a transmitting section 832 ((9) in FIG. 20), and is passed to secure device 820. A decryption section 833 of secure device 820 decrypts the encrypted license issuance app using a private key held in a private key storage section 834 ((10) in FIG. 20). The license issuance app decrypted only with the key of secure device 820 and still encrypted with the public key of secure device 801 is stored in a secure storage area by a license issuance app storage section 824 ((11) in FIG. 20).

(License Issuance App Transfer)

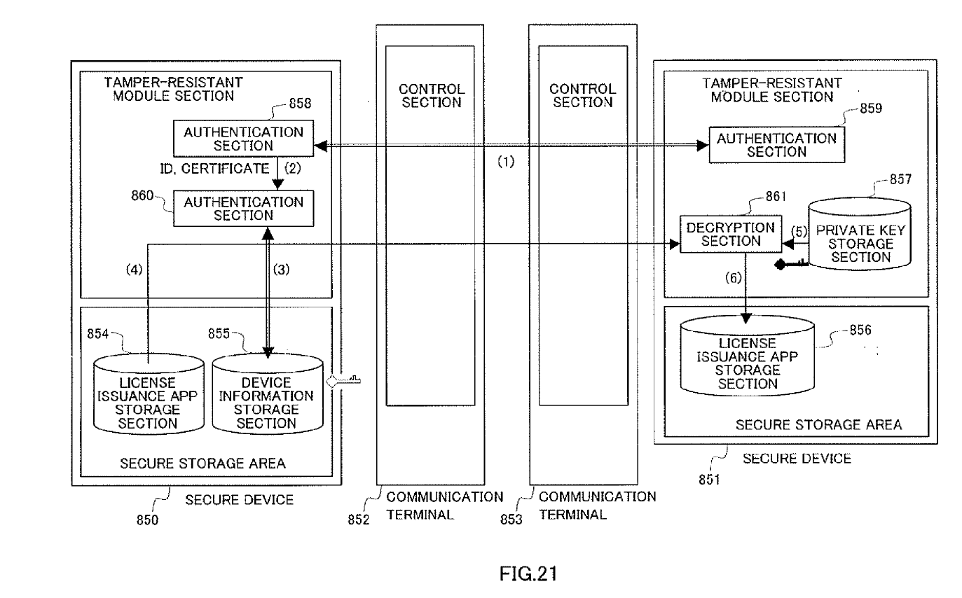

This will be explained using FIG. 21. A secure device 850 and a secure device 851 perform communication using an information terminal with two card slots or information terminals with the respective secure devices inserted, and the fact that these are legal devices is authenticated by authentication sections 858 and 859 ((1) in FIG. 21). When authentication is successful, secure device 850 receives an ID and public key certificate for secure device 851 ((2) in FIG. 21), and an authentication section 860 authenticates whether or not an ID matching the received ID is stored in a device information storage section 855 ((3) in FIG. 21). Then, if authentication is successful, secure device 850 transmits to secure device 851 the license issuance app acquired by proxy for that ID ((4) in FIG. 21). As the license issuance app has been encrypted with the public key of secure device 851, a decryption section 861 in secure device 851 decrypts the received license issuance app using a private key of secure device 851 stored in a private key storage section 857 ((5) in FIG. 21). The decrypted license issuance app is stored in a license issuance app storage section 856 ((6) in FIG. 21).

The present application is based on Japanese Patent Application No. 2004-135700 filed on Apr. 30, 2004, entire content of which is expressly incorporated herein by reference.

### INDUSTRIAL APPLICABILITY

A content use management method of the present invention can be used in DRM of various kinds of digital content including music, video, and books, or software such as games and applications and the like, distributed via a network, recording medium, or the like.

Also, a secure device of the present invention is applicable as a card type or chip type device, or in a mode whereby it is inserted into a mobile phone or the like in which a reader is incorporated.

Furthermore, a playback terminal of the present invention can be applied to a variety of devices that utilize (play back, transfer, duplicate, print, and so forth) digital content, such as a mobile phone, PDA, PC, AV device, or the like.

1. A content use management method, comprising:
after storing a group key in a secure device that executes computation in a concealed state and stores data in a concealed state, storing a same group key in said secure device and a playback terminal by sending said group key from said secure device to said playback terminal;
after receiving a license issuance application that issues a content license from a license distribution server and storing in said secure device, storing a license encrypted with said group key in said playback terminal by sending said license encrypted with said group key from said secure device to said playback terminal; and
decrypting by said playback terminal, when using encrypted content, said license with said group key and extracting a content decryption key contained in said license, and decrypting encrypted said content with said decryption key.

2. A secure device that executes computation in a concealed state and stores data in a concealed state, comprising:
a random number generation section that receives a group key generation command and generates a random number;
a group key storage section that stores a random number generated by said random number generation section as said group key; and
a group key issuance section that transmits said group key stored in said group key storage section to a playback terminal in a concealed state.

3. The secure device according to claim 2, further comprising:
a license issuance application storage section that stores a license issuance application that issues a content license and that is received from a license distribution server via a communication terminal;
a license issuance section that executes said license issuance application and issues a license in accordance with a characteristic of content used by a playback terminal; and
an encryption section that encrypts issued said license with said group key.

4. The secure device according to claim 3, wherein said license issuance section receives only data information of said license issuance application from said license distribution server and stores said data information in said license issuance application storage section, holds beforehand an execution program of said license issuance application, and reads said data information from said license issuance application storage section and issues a license.

5. A playback terminal that holds encrypted content and plays back said content, comprising:
a group key storage section that stores in a concealed state a group key received from an inserted secure device;
an encrypted license storage section that stores a license encrypted with said group key, received from said secure device;
a first decryption section that decrypts encrypted said license with a group key stored in said group key storage section when playback of said content is performed; and
a second decryption section that extracts a decryption key of said content from decrypted said license and decrypts encrypted said content with said decryption key.

6. The playback terminal according to claim 5, further comprising:
a profile storage section that stores characteristic information of content for which playback is possible; and
a transmitting section that transmits information stored in said profile storage section to said secure device prior to reception of said license from said secure device.

7. A license distribution server that distributes a content license, comprising:
a license management database that stores a decryption key and usage condition of content;
an information extraction section that extracts necessary information from said license management database according to a license distribution request;
an application generation section that generates a license containing a decryption key and usage condition of content from extracted information, and generates a license issuance application for generating a content license from a license of each generated format; and
a transmitting section that distributes generated said license issuance application.
